(19) United States
(12) Patent Application Publication
(10) Pub. No.: US 2021/0102066 A1
(43) Pub. Date: Apr. 8, 2021

(54) MECHANORESPONSIVE POLYMERS EXHIBITING LOW-ENERGY MOLECULAR SWITCHING

(71) Applicant: THE REGENTS OF THE UNIVERSITY OF CALIFORNIA, Oakland, CA (US)

(72) Inventors: Jennifer Lu, Mercerd, CA (US); Xingyuan Shen, Merced, CA (US); Erin R. Johnson, Merced, CA (US)

(73) Assignee: THE REGENTS OF THE UNIVERSITY OF CALIFORNIA, Oakland, CA (US)

(21) Appl. No.: 17/035,050

(22) Filed: Sep. 28, 2020

Related U.S. Application Data
(63) Continuation of application No. PCT/US2019/025608, filed on Apr. 3, 2019.
(60) Provisional application No. 62/652,089, filed on Apr. 3, 2018.

(51) Int. Cl. C08L 79/00

(52) U.S. Cl. CPC C08L 79/00; C08L 2205/025

(57) ABSTRACT

Tunable negative thermal expansion linear polymer materials with reversible large-scale mechanoresponse under low-energy stimulation and fabrication methods are provided. The reversible thermal contraction of the material is due to a molecular switch, s-dibenzocyclooctadiene (DBCOD), which undergoes a twist-boat to chair conformational change when heated or radiated by near-infrared light. The DBCOD moieties are present as either crosslinkers or polymer main-chain units and the corresponding polymers can have different amounts of DBCOD units in the polymer main chain. The various DBCOD monomers can be covalently incorporated into a variety of polymeric materials to construct negative thermal expansion or zero expansion materials for the specific applications.

### CROSS-REFERENCE TO RELATED APPLICATIONS

This application claims priority to, and is a 35 U.S.C. § 111(a) continuation of, PCT international application number PCT/US2019/025608 filed on Apr. 3, 2019, incorporated herein by reference in its entirety, which claims priority to, and the benefit of, U.S. provisional patent application Ser. No. 62/652,089 filed on Apr. 3, 2018, incorporated herein by reference in its entirety. Priority is claimed to each of the foregoing applications.

The above-referenced PCT international application was published as PCT International Publication No. WO 2019/195442 A1 on Oct. 10, 2019, which publication is incorporated herein by reference in its entirety.

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

The technology of this disclosure pertains generally to negative-thermal-expansion (NTE) materials and methods of fabrication, and more particularly to materials with a molecular switch, s-dibenzocyclooctadiene (DBCOD), which undergoes a conformation change when heated or irradiated by near-infrared light and tunable polymer nanocomposite materials with controllable thermal properties.

### 2. Background Discussion

Most solid materials expand in volume upon heating under constant pressure. Some materials have the unusual property of volume contraction with increasing temperatures under constant pressure and these are called negative thermal expansion (NTE) materials. Low-energy-driven shape changing materials are of great technological interest and have a wide variety of potential applications.

Photo/thermal mechanoresponsive materials have been studied for several decades. Existing molecular switches rely on optical/ultraviolet stimulation to trigger cis-trans isomerization of N═N or C═C double bonds. However, in these systems, high-energy photons are only absorbed at the material surface and damage after extended cycling is unavoidable, especially for bio-applications.

Other shape-changing materials exhibit large volume changes caused by thermal transitions at a critical temperature by various processes, such as order-disorder transitions, swelling processes, and glass or melting transitions. However, large-scale polymer chain rearrangement always leads to fatigue and degradation in these systems.

Still other reported negative-thermal-expansion (NTE) materials show contraction over a wide temperature range with better reliability, but with much lower NTE coefficients, of at most −200 ppm/K. Furthermore, the matrixes of these materials are mainly inorganic oxides, metal-organic frameworks and organic crystals which, unlike polymers, are hard to use in preparations with other materials to form composites.

The majority of NTE materials that have been identified are inorganic materials such as metal oxides and zeolites. These materials have been used to suppress the coefficient of thermal expansion (CTE) by forming composites such as ZrW2O₈ and GaNMn₃/epoxy composites, and Zr₂WP₂O₁₂ and ZrW2O₈/polyimide composites, for example.

Organic materials such as organic frameworks, organic crystals, and liquid-crystalline materials offer significantly higher NTE values than inorganic NTE materials. However, they are often chemically and thermally unstable. In addition, one direction of thermal contraction is usually accompanied by thermal expansion of other directions with these materials.

Often, an increase in the macroscale dimensions of a material that occurs with an increase in temperature can cause fatigue, cracking and delamination ultimately leading to deterioration of the material. Composites of materials that include components that exhibit negative thermal expansion to mitigate material deterioration have also been investigated. However, most of these systems possess weak interface connectivity between NTE components and their surrounding matrix materials. In addition, these materials do not offer a desirable CTE at a suitable temperature window for practical applications.

Accordingly, there is a need for NTE materials that have a large NTE and are tunable to device operation temperatures that are easy to process and are durable.

### BRIEF SUMMARY

A low-energy driven thermal contraction polymer system is provided with polymers that are composed of many covalently-bonded thermal contractile units that contract in response to small increases in ambient temperature. The polymers contain a plurality of sub-molecular switches of s-dibenzocyclooctadiene (DBCOD) which undergo a conformation change when heated or exposed to near-infrared light to produce the reversible large-scale mechanoresponse under low-energy stimulation. The DBCOD thermal contractile unit has a flexible eight-member ring flanked by two rigid phenyl groups, that undergoes a reversible conformational change much like proteins. For DBCOD, heat causes contraction when its thermodynamic global minimum conformation (twist-boat) switches to a local minimum conformation (chair).

The basic thermal contractile unit may have one or more monomer or polymer molecules coupled to the unit rings through substituted amide, carboxyl or other types of bonding. Mixtures of different configurations of DBPOD monomer/polymer starting structures at selected molar ratios can be assembled to tune the characteristics of the final material. For example, controlled mixtures of meta-substituted and para-substituted DBCOD monomers/polymers can be formulated to introduce different degrees of structural randomness into the final fabricated material. It is possible to model the synthesis of DBCOD single molecule systems with different substitution patterns and types to manipulate the thermodynamics (equilibrium positions) and kinetics (activation energies) with various DBCOD's conformations.

The DBCOD moieties may be present as either crosslinkers or main-chain units in these polymers. The unconventional mechanoresponse can be controlled by small variations in the sub-molecular environment around the DBCOD moieties (e.g. hydrogen-bond strengths and steric interactions), or by nano-scale environmental change (e.g. crystallinity) as well as the number or concentration of thermal contraction units in the base material. The addition of nano scale carbon particles or functionalized carbon particles such as carbon nanotubes can also tune the environment surrounding the DBCOD moieties and improve the NTE of the composite materials.

The DBCOD monomers/polymers may be used in applications requiring zero- or low-thermal-expansion materials and may be combined with other, normal polymers, since the coefficient of thermal expansion could be adjusted by changing the ratio of the components.

In some embodiments, the DBCOD polymers from this polymer group can be deposited to form a layer of aligned fibers or attached as an aligned film on a piezoelectric polymer with metal contacts, forming a piezoelectric sensor or transducer for energy conversion and storage. This material is also an excellent candidate for heliophilic devices.

The family of polymers of the present technology have many advantages over existing polymer materials. Compared with current photo/thermal mechanoresponsive materials, the main advantage of the polymers in this invention is the low energy required to trigger contraction. DFT results indicate that the activation enthalpy for the conformational change of DBCOD derivatives (twist-boat to chair) is 0.90 eV. Experimentally, the polymer films have been shown to undergo thermal contraction by heating or using an NIR light source at wavelengths up to 1,540 nm (0.81 eV). Since heat is ubiquitous and wasted in, for example internal combustion engines, such low-energy stimulated mechanoresponsive materials should be valuable for applications in energy storage and conversion.

The thermal contraction of the materials is also fast and completely reversable. Conformational changes of the materials are reversible and there are many examples in living systems of conformational equilibria. Macroscopic cycle performance tests show that the DBCOD conformational change is intrinsically fast and that the thermal contraction behavior is completely reversible over at least 500 cycles demonstrating that DBCOD conformational change is highly reversible.

The polymers in this technology also exhibit a giant coefficient of thermal contraction of approximately −2300 ppm/K under ambient conditions. This absolute value is much higher than that of all normal, solid thermal-expansion materials. The monomers/polymers could therefore be combined with other normal polymers to make new composites exhibiting zero/low thermal expansion under ambient conditions. The polymeric matrix provides the capability for preparing tuned composites with desired thermal-expansion coefficients. In addition, the giant anomalous mechanical contraction and large coefficients of negative thermal expansion (NTE) were observed in materials where the polymer only contained a relatively small number of DBCOD units, with a coefficient of thermal expansion of −2350 ppm/K, for example. This is approximately 10 times greater than reported by the best NTE material systems currently existing.

The polymer family also allows the production of highly tunable materials. The conformational energy landscape can be adjusted via tuning of local hydrogen-bond strengths by changing the position and identity of substituents on the benzyl rings of the DBCOD moiety or by varying the nano-scale environment in the polymer with different linking monomers. Consequently, the thermal behavior can be tailored significantly for target applications.

This new polymer family could generate materials with unique properties that otherwise have been unattainable and could entail significant technological ramifications. For example, high-performance electronic devices require electronic-packaging polymers featuring a low coefficient of thermal expansion (CTE). This can be accomplished by embedding thermal contractile units in the existing polymers to act as thermal expansion compensators.

In another embodiment, a bi-layer polymer system in which one layer expands while the other layer contracts can serve as the basis of energy-efficient wearable robots that operate in the physiologically relevant temperature range. This is critical for biomedical applications.

Accordingly, polymer molecular design and simulation can be employed to synthesize new mechanoresponsive systems. For example, new types of nanoporous polyarylamide films have been fabricated that contain s-dibenzocyclooctadiene (DBCOD) as an intermolecular cross-linker. These films generate unconventional mechanical contraction that is fully recoverable in response to either near infrared (NIR) or thermal stimulation. They possess an extremely large negative thermal expansion coefficient (NTE) of approximately −2300 ppm/° C. under ambient conditions, much higher than the best previously known NTE materials at these operating conditions. Significantly, there is no sign of fatigue after extended cycling. Both spectroscopic analysis and density-functional theory calculations indicate that this abnormal thermal shrinkage is likely due to conformational change of the DBCOD moiety, from the thermodynamic global minimum, twist boat, to a local minimum, chair. Since this conformational change does not involve a transition between electronic states, low-energy NIR photons (˜0.8 eV) are sufficient to induce the conformation change, as opposed to UV photons (˜3.4 eV) that are required for conformational change in the well-known C═C and N═N systems. Moreover, these films are “transparent” to the stimulation energy sources, heat or NIR, and thus all moieties in the entire cross-section of a film will undergo conformational change. Large and stable NTE, in combination with the use of low-energy sources for mechanical deformation, opens a new pathway for green energy-based actuation and energy conversion.

There are many applications where (i) lower thermal expansion is desirable such as semiconducting packaging materials, or (ii) material's shapes need to be changed in response to thermal stimuli such as sunlight (heliotropic devices) or heat from sources such as exhaust pipes for thermal energy harvesting or (iii) an NIR-based actuators such as a bio-pumps. There are several polymer systems such as polyamides (nylon derivatives), polyurethanes and polyureas where DBCOD moieties with engineered local environments such as hydrogen bonding strength can be incorporated and utilized to address the aforementioned needs.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE SEVERAL VIEWS OF THE DRAWINGS

The technology described herein will be more fully understood by reference to the following drawings which are for illustrative purposes only:

FIG. 1A is a schematic structural diagram of DBCOD moiety and reversable conformation change from twist-boat to chair conformation according to one embodiment of the technology.

FIG. 1B is a schematic structural diagram of DBCOD moiety in the polymer main chain and reversable conformation change from twist-boat to chair conformation according to another embodiment of the technology.

FIG. 2A is a schematic structural diagram of 3,4′-ODA polymer with both meta and para substituted amide structures.

FIG. 2B is a schematic structural diagram of 4,4′-ODA polymer with only a para substituted amide structure.

FIG. 3A is a schematic structural diagram of a polymer chain according to an alternative embodiment of the technology.

FIG. 3B is a diagram of a synthesis route for main-chain DBCOD monomers that can be synthesized as syn (a₁, a₂) and anti (b₁, b₂) isomers by different routes.

FIG. 3C is a diagram of a synthesis route for triblock main-chain polymers according to a further embodiment of the technology.

FIG. 3D is a diagram of an alternative route for synthesis of DBCOD-main-chain polymers via the Diels-Alder reaction.

FIG. 4A and FIG. 4B is a diagram of synthesis schemes for DBCOD molecules and monomers with ester substituents that are located at syn and anti positions with respect to each other.

FIG. 5 is a diagram of a synthesis scheme for incorporation of the DBCOD units into conventional packaging polymer materials.

FIG. 6 is a diagram of a synthetic scheme for DBCOD molecules and monomers with DBCOD as a crosslinking molecule.

FIG. 7 is a diagram showing possible substitution on the DBCOD base structure.

FIG. 8A is a diagram of a synthetic route for di-COOH-substituted DBCOD for main-chain monomers

FIG. 8B is a diagram of the chemical structure of synthesized polyarylamide copolymers.

FIG. 9 is a schematic side view of an automatous solar tracking system in the dark and illuminated positions according to one aspect of the technology.

FIG. 10 is a perspective view of a composite of a base material layer and a DBCOD polymer layer according to the technology.

### DETAILED DESCRIPTION

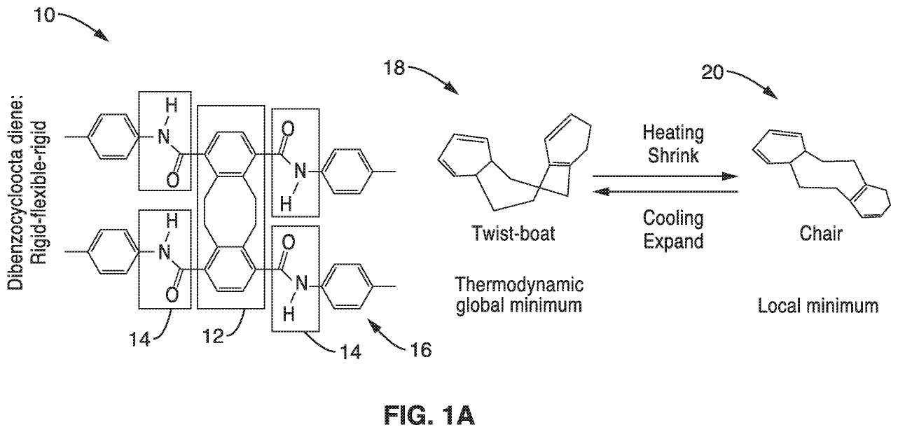

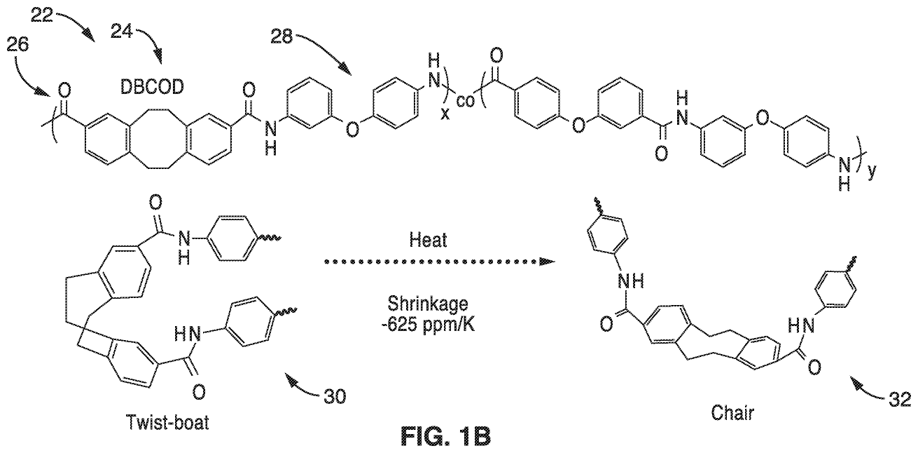

Referring more specifically to the drawings, for illustrative purposes, embodiments of materials and methods for fabricating a tunable thermal polymer system centered on s-dibenzocyclooctadiene (DBCOD), a molecular switch comprising a flexible cyclooctane group connected to two rigid phenyl rings are generally shown. Several embodiments of the technology are described generally in FIG. 1A to FIG. 10 to illustrate the characteristics and functionality of the materials, methods and suitable devices. It will be appreciated that the methods may vary as to the specific steps and sequence and the systems and apparatus may vary as to structural details without departing from the basic concepts as disclosed herein. The method steps are merely exemplary of the order that these steps may occur. The steps may occur in any order that is desired, such that it still performs the goals of the claimed technology.

Turning now to FIG. 1A, one embodiment of a DBCOD unit 10, a sub-molecular moiety is shown with tetra-amide substitutions that will undergo a conformational change from a twist-boat 18 to a chair 20 configuration under a low-energy stimulus such as near infrared irradiation. The DBCOD-based polymer system demonstrates reversible thermal contraction behavior with negative thermal expansion (NTE). Unlike conventional sub-molecular switches, such as azobenzene, spiropyran or overcrowded alkenes that require high-energy UV or blue photons to induce a mechanoresponse, the mechanoresponse of the DBCOD-containing polymers can be triggered using photons with one-third of the energy needed for photoisomerization or heating a few degrees above room temperature.

The unit 10 has a s-dibenzocyclooctadiene (DBCOD) core 12, a flexible cyclooctane group that is an eight membered ring connecting two rigid phenyl rings, with carboximide substituents 14 that couple monomers/polymer chains or other groups 16 to the core 12. The conformational change of the DBCOD switch core 12, from the twist-boat 18 (global energy minimum) to the chair 20 conformation (a local minimum) is the molecular origin of the observed negative thermal expansion (NTE) mechanoresponse as shown in FIG. 1A.

Another embodiment of a dicarboxyl-substituted DBCOD functional monomer 22 and conformational changes are shown in FIG. 1B. This monomer, for example, can be covalently incorporated into a variety of polymeric materials to construct negative thermal expansion or zero expansion material for various applications.

In the configuration in this embodiment, the DBCOD core 24 is coupled to selected monomer chains 28 through two carboxyamide links 26. The enthalpy-driven conformational transition of the DBCOD moiety from the twist-boat configuration 30 to the chair configuration 32 with the application of heat or radiation is also shown in FIG. 1B.

As with the embodiment of FIG. 1A, a wide variety of monomer or polymer chains or groups 16, 28 can be coupled to the DBCOD moiety core 24. For example, the DBCOD core can serve as a crosslinking agent to cross link coupled monomers or polymers or the core can be placed within the polymer main chain and not serve as a polymer cross-linking site as shown in FIG. 1B.

In one embodiment, the cross-linkable monomers or polymers coupled to the DBCOD core are of different types with one type coupled on one side of the core and another type coupled to the other side of the core.

In another embodiment, the polymerized material may include nanoscale carbon particles such as carbon nanotubes or few walled carbon nanotubes. The carbon particles can also be functionalized such as carbon nanotubes functionalized with carboxyphenyl groups, carboxylic acid groups; amino groups and chloride groups.

The material may also have additional monomers or polymers that are cross-linked to the substituted polymers 16, 28 and not directly coupled to the DBCOD core. In one embodiment, a cross-linking agent is used to cross-link the core coupled polymers with the non-coupled polymers that are to be present in the material.

Experimental results indicated that the conformation conversion can be improved and the mechanical contraction of the material increased, with DBCOD core units disposed in an amorphous and less packed physical environment. In other words, a less-crystalline environment around the molecular switch facilitates its conformational change and control over the nature of the environment surrounding the DBCOD units can tune the material.

It was found that sub-molecular substitution of the core can be used to introduce molecular asymmetry that can facilitate the DBCOD conformational conversion, leading to larger negative thermal expansion. Consequently, the negative thermal expansion (NTE) coefficient of a DBCOD-based polymer is tunable by adjusting the chemical structure and tailoring the local physical environment surrounding the unit.

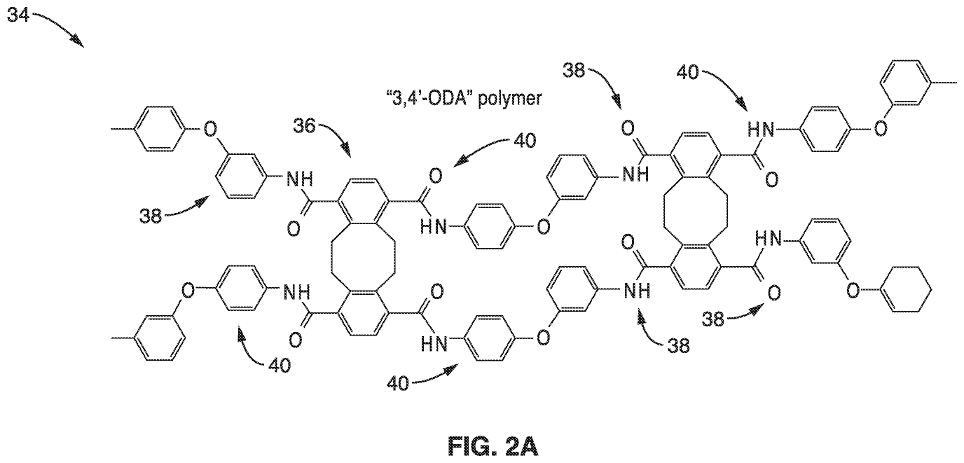

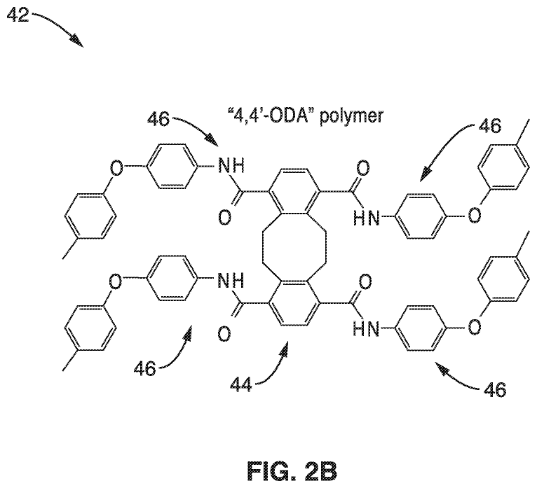

One illustration of the sensitivity of the NTE coefficient to the local environment in which the DBCOD resides is shown in FIG. 2A and FIG. 2B and Example 1. The structure of 3,4′-oxydianiline (3,4′-ODA) polymer 34 is generally shown in FIG. 2A. There, the DBCOD core 36 has one meta-substituted amide 38 and three para-substituted amides 40 or three meta-substituted amides 40 and one para-substituted amide 38.

The 4,4′-oxydianiline (4,4′-ODA) polymer 42 structure is shown generally in FIG. 2B. The DBCOD core 36 has four para-substituted amides 46 in this illustration providing a more crystalline environment around the molecular switch 36. The 3,4′-ODA has both meta- and para-substituted amides that are randomly present in a polymer chain producing a less ordered material compared to the 4,4′-ODA crystalline structure of only para-substituted amides.

As a result, crystallinity is significantly reduced due to the introduction of structural randomness. The amorphous-like environment prepared from 3,4′-ODA is more kinetically favorable for conformational changes than the semi-crystalline film prepared from 4,4′-ODA. Molecular dynamics calculations also predict that the polymer prepared with 3,4′-ODA possesses less ordered morphology and loosely packed structure.

Replacing (4,4′-ODA) with some quantity of (3,4′-ODA) can produce a polymer that can exhibit an enhancement of twice the NTE value from −1140 ppm/K to −2350 ppm/K. This represents net 10 times higher thermal contraction than that of the next-best reported material.

Accordingly, it is possible to tailor the NTE values of the material by adjusting the stoichiometry of the polymer precursors, i.e. 3,4′-ODA and 4,4′-ODA percentages.

NTE material performance can also be improved by controlling the number and the location of the DBCOD units in the polymer structures. In some settings, the number of DBCOD units in the polymer is uncertain due to great numbers of side reactions that can occur in a BCB dimerization synthesis scheme. In other settings, the DBCOD conformational transition may be sluggish when DBCODs units are located in cross-linking positions or when the dimerization temperature is close to the polymer degradation temperature during the formation of the material.

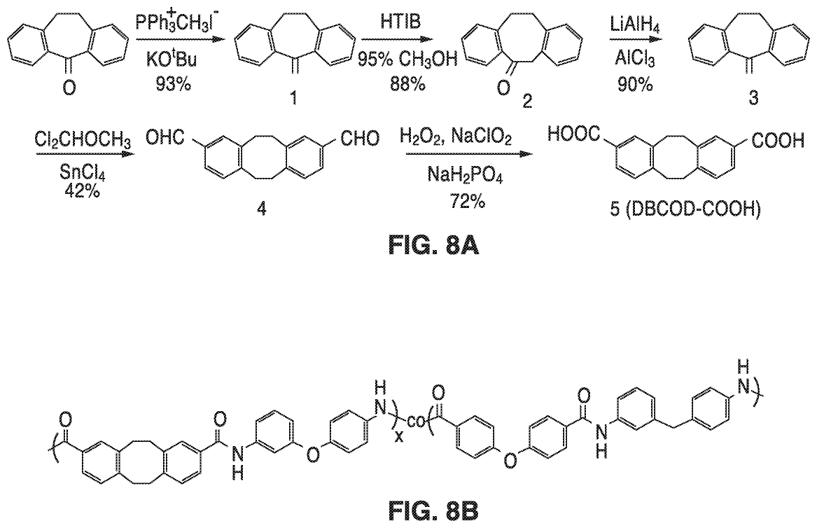

In one embodiment, DBCOD-containing functional monomer and corresponding polymers can be produced with a synthetic route where DBCODs are located in the main chain rather than in the cross-linking portions of the polymer as illustrated in FIG. 8B and Example 2.

In this embodiment, (1) the amount of DBCODs units in the material is known and can be adjusted, (2) the DBCODs units are not in the cross-linking positions and thus the polymers can be readily processed such as aligning all DBCODs for even greater thermal contraction in a specific direction, and (3) the polymer also can be reworked.

Accordingly, the intrinsic reversible thermal contraction of the DBCOD moiety can be harnessed to produce material platforms with a tunable coefficient of thermal expansion (CTE) and a molecular-scale mechanical response obtained with low-energy simulation (near-infrared or heat). The present materials will allow the production of many different types of devices that are centered on negative thermal expansion.

For example, the present materials will allow the production of sensors or transducers for energy conversion and storage. In all mechanical processes, a considerable amount of usable energy is wasted as heat. Much of the energy generated from internal combustion engines is lost as heat waste. Resulting temperature fluctuations would allow the reversible conformational change of DBCODs incorporated into polymer films and used as mechanical energy. If a film of DBCOD-containing polymer is deposited on a piezoelectric polymer with metal contacts, the reversible deformation encountered by the piezoelectric film will be converted into electricity. Polymer fibers prepared by electro-spinning can be similarly applied. One of the advantages of using fibers is that the molecules can be more easily aligned and a device can be designed where the top DBCOD layer thermally contracts longitudinally whereas the bottom DBCOD layer contracts laterally. Such a photo/thermal-mechanical-electrical sensor or transducer could be applied for the conversion and storage of waste energy.

The present materials may also allow the production of zero/low coefficient of thermal expansion materials and associated devices. The differences between thermal expansion properties of ordinary materials have become a significant barrier towards the design of material interfaces, e.g. in polymer composites and precision instruments. For example, because of their different coefficients of thermal expansion, metal and polymeric substrates will expand at different rates when heated, damaging devices such as microchips. This damage could be minimized provided that the coefficient of thermal expansion of one component, in this case the polymer, could be adjusted. However, previously-reported negative thermal expansion materials do not possess sufficiently-large contraction ability. Moreover, none of these materials is a polymeric matrix and it therefore difficult to prepare a composite.

Several different DBCOD monomers have been shown to produce polymers that possess NTE coefficients as high as −2300 ppm/K, the absolute value of which is higher than the NTE coefficients of most normal materials. The DBCOD unit can incorporate many existing packing polymers to form homogeneous materials with engineered CTE, for example.

There are two methods to prepare materials with compositions to give near-zero thermal expansion: 1) as a copolymer or 2) as polymer mixture. In a copolymer, the NTE coefficient of the final polymer will be determined by the ratio of DBCOD-containing monomers and other monomers in the final material. In a mixture, for better compatibility, the DBCOD-containing polymer could be prepared first and then mixed with a normal polymer by a predetermined ratio.

Thermal contraction as a function of temperature rise can also be harnessed for thermal management. Because of the endothermic nature of the DBCOD conformational change, a cooling system that does not require power and contains no moving parts can be built with an overheating protection feature. When the temperature of a device exceeds 60° C., for example, the DBCOD conformational change absorbs heat will take place. This thermodynamic transition will cool the material and alleviate overheating.

The materials can also be adapted to biological applications. Control of biological activity by light has already been realized by the incorporation of molecular photo-switches into biomolecules and bioactive compounds, as exemplified by optical control of bio-receptor affinity. However, high-energy light can be damaging to biological systems and has a limited actuation range due to strong absorption by water. This new type of conformational molecular switch allows the creation of new bio-devices (e.g. for targeted drug delivery) that can be regulated by NIR, for example.

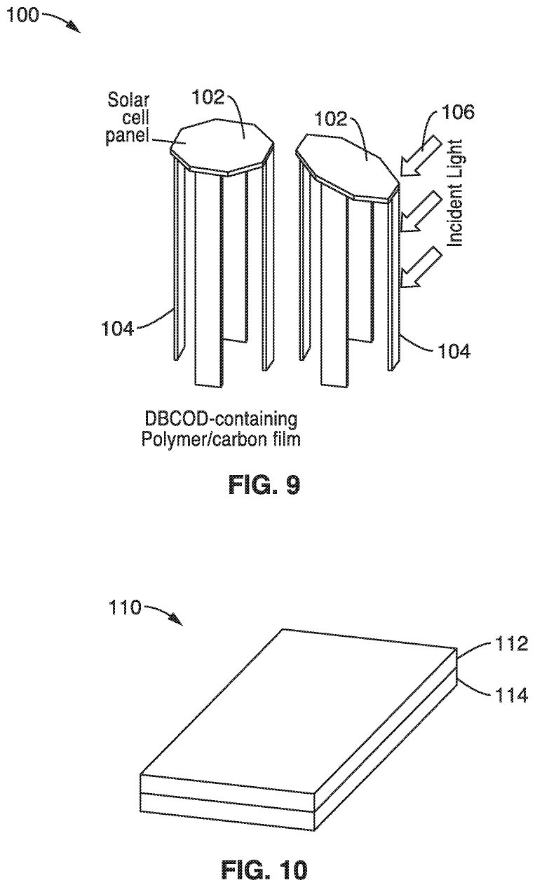

The great thermal sensitivity of DBCOD-containing polymers can also be exploited for thermal sensing. For example, a nano-thermometer can be prepared by incorporating DBCOD-containing polymer into an artificial skin to detect temperature by stress changes. Another promising application is a thermally-responsive heliotropic device for effective solar energy harvesting. Enlightened by heliotropism in nature, artificial heliotropic devices that can follow the sun will enhance light exposure and increase the efficiency and reduce the required numbers of solar panels. One possible device is comprised of a solar panel with four planted DBCOD-containing polymeric “legs”. The shrinkage of the “leg” with greatest exposure to sunlight will drag the panel to better face the sun as illustrated in FIG. 9. The low-energy influx needed to drive contraction endows this polymer with the thermal-sensitivity properties that make it an excellent candidate for heliotropic devices.

The technology described herein may be better understood with reference to the accompanying examples, which are intended for purposes of illustration only and should not be construed as in any sense limiting the scope of the technology described herein as defined in the claims appended hereto.

### EXAMPLE 1

Fabrication and functionalization of the DBCOD moiety can take several different pathways. Several synthesis schemes were formulated and evaluated. In one preferred embodiment, a triblock polymer with a PEO (soft-segment) and a poly(XTA-b-ODA) (rod segment) can be used to prepare DBCOD by condensation polymerization. The benzocyclobutene (BCB) group is a unique feature in the polymer and can be dimerized to form the DBCOD structure after annealing in inert gas to form a robust, cross-linked porous film. The resulting film exhibits an abnormally-large contraction when heated or exposed to near-infrared (NIR) radiation and coefficient of thermal expansion of this polymer was measured as −1100 ppm/K. The mechanism of this unique thermal contraction is due to the conformational change of DBCOD, from the thermodynamic global energy minimum (twist-boat) to a local minimum (chair). Reliability tests of this polymer film indicate that the thermal contraction is completely reversible over hundreds of cycles.

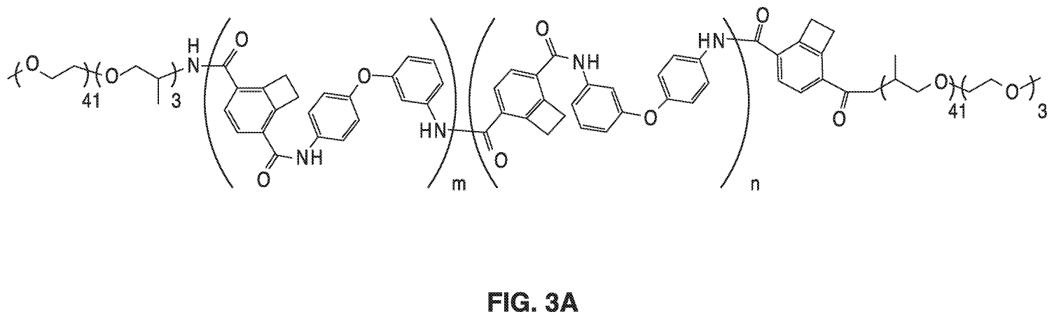

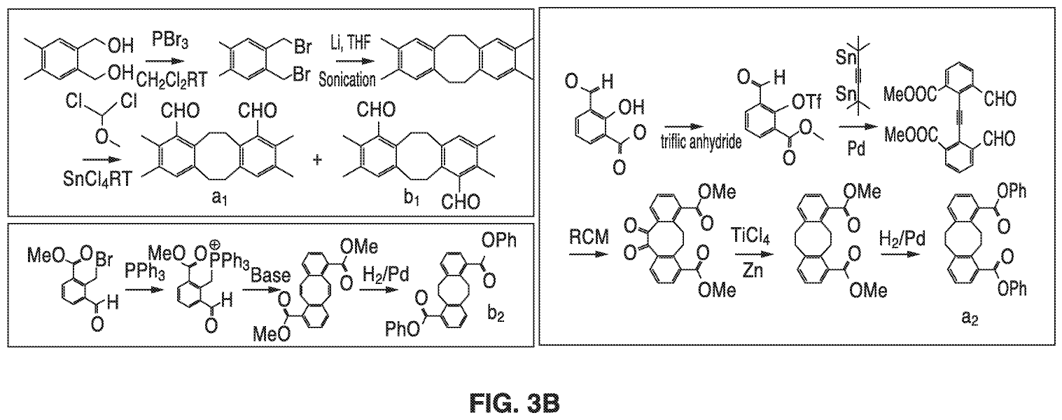

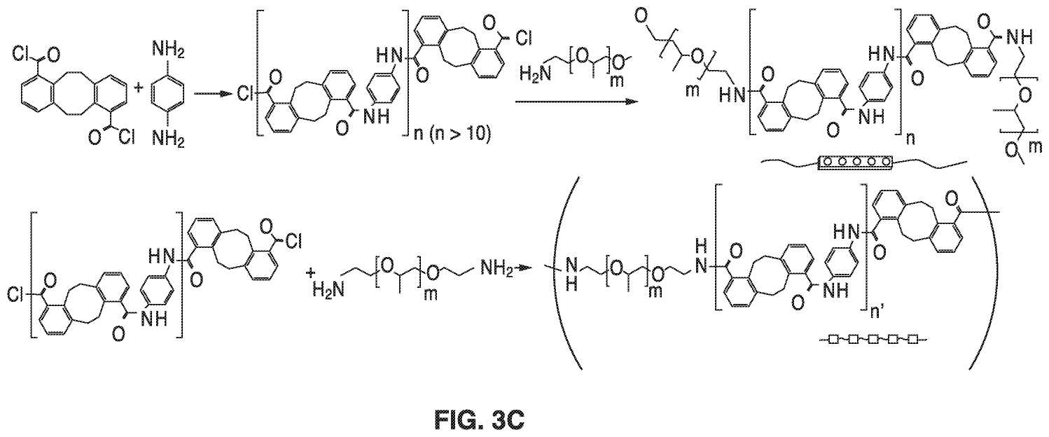

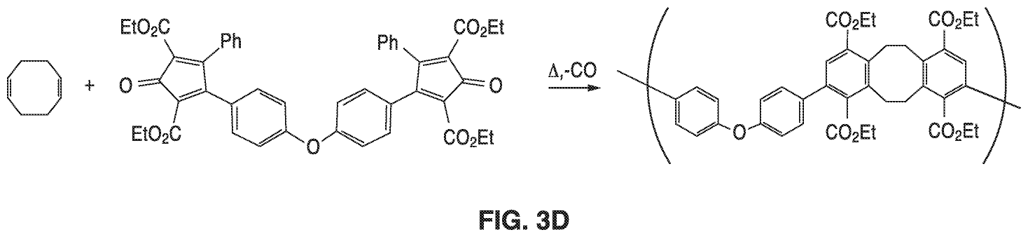

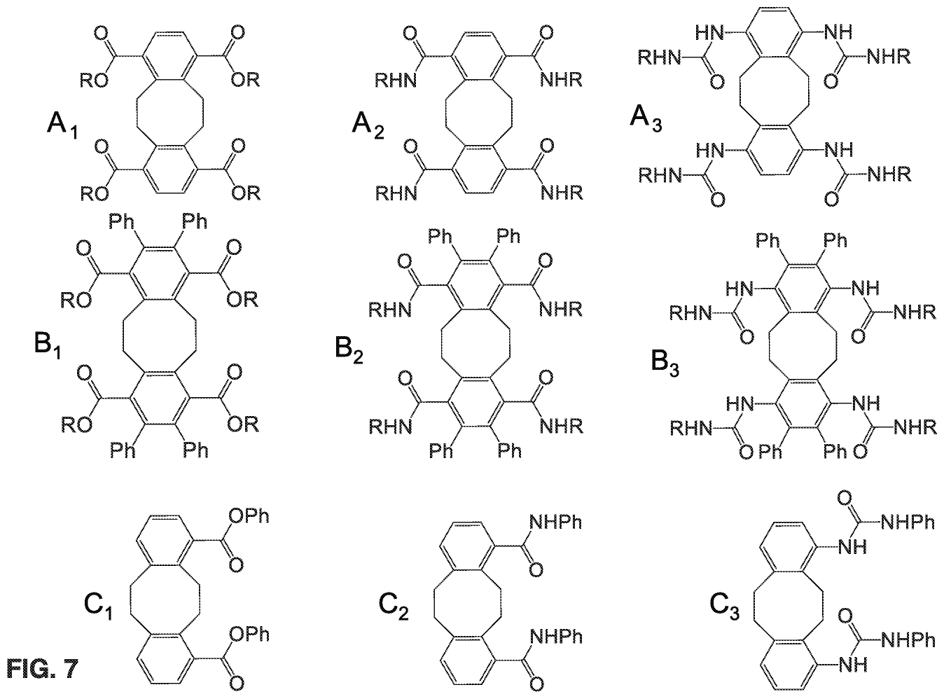

In another embodiment, a composite film was then prepared, in which functionalized carbon nanotubes could not only disperse well in the DBCOD-containing polymer matrix, but also form covalent linkages directly with the polymer chains. Due to the excellent thermal conductivity of carbon nanotubes, all DBCOD moieties in the bulk can participate in the conformational change, thus leading to significantly higher conversion efficiency than seen with UV-induced isomerization. Moreover, a much larger NTE coefficient of −2300 ppm/K is observed in an alternative polymer structure, as shown in FIG. 3A. The less-crystalline environment around the molecular switch facilitates its conformational change, leading to this enhancement. DFT results demonstrated that hydrogen bonds involving substituents on the DBCOD group can stabilize the twist-boat conformer, leading to higher enthalpy difference between the two conformers that shifts the equilibrium and affects the mechanical response. As shown in FIG. 7, several substitution patterns are possible on the DBCOD base structure and several model structures with different hydrogen-bond strengths (amide, ester, urea) can be exploited.

In the previous illustrations, the DBCOD moiety acts as a polymer cross-linker, but it also could be present as a main-chain unit to increase the number of sub-molecular units capable of conformational change and amplify the mechanical response. As shown in FIG. 3B, the main-chain monomer could be synthesized as syn (a₁, a₂) and anti (b₁, b₂) isomers by different synthesis routes.

The subsequent preparation route is shown schematically in FIG. 3C for both triblock and alternating polymers. In the triblock polymers, the semi-rigid domain formed by the self-assembly of DBCOD-containing segments will further restrain the chain movement and may slowdown the conformational kinetics. In the alternating polymer, the DBCOD-containing unit is connected to two small soft-segments, which facilitates the DBCOD conformation change. A DBCOD-main-chain polymer embodiment with urea linkages to stabilize the twist-boat conformer for high-amplitude mechanoresponse is shown.

An alternative route for synthesis of DBCOD-main-chain polymers via the Diels-Alder reaction is shown in FIG. 3D.

### EXAMPLE 2

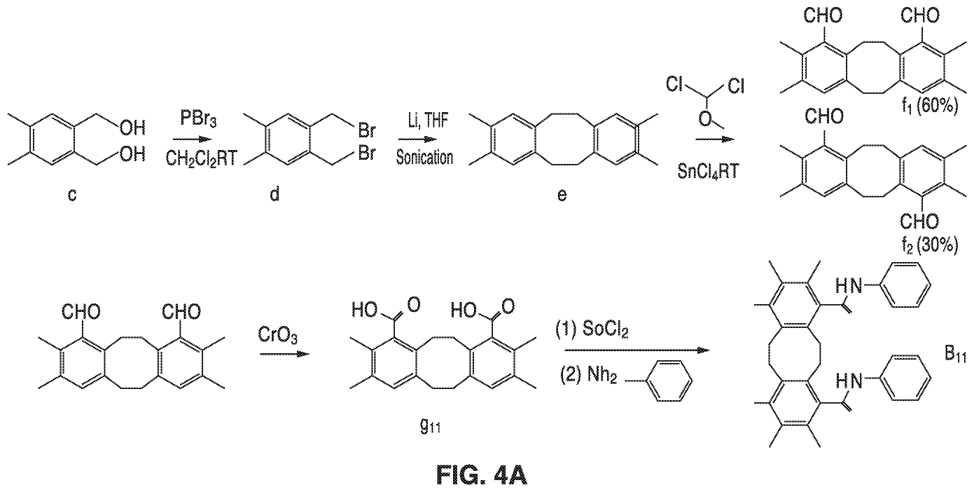

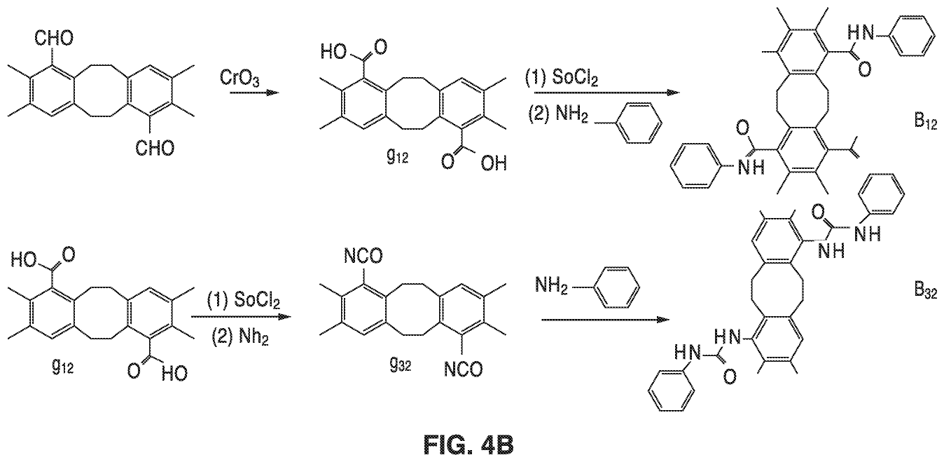

To further illustrate the invention, one embodiment of a scheme for synthesizing DBCOD small molecules and monomers is described. The synthetic route shown collectively in FIG. 4A and FIG. 4B will first provide DBCOD systems with ester substituents that are located at syn and anti positions with respect to each other. First, as seen in FIG. 4A, the tetramethyldibenzocyclooctadiene-dicarboxylic acid (compounds g₁₁ and g₁₂), were prepared from commercially available 4,5-dimethylbenzene-1,2-dimethanol (compound c). Compound c was brominated with phosphorous tribromide to give dibromide (compound d), was then dimerized by reaction with lithium to provide the dibenzocyclooctadiene derivative (compound e of FIG. 4A). The Rieche procedure with two equivalents of dichloromethoxymethane was performed resulting in a mixture of compounds f₁ and f₂. Column chromatography was used to separate compounds f₁ and f₂. The yield shown in FIG. 4A is after column chromatography. This synthesis can be done on a large scale. Oxidation with chromium trioxide will give compounds g₁₁ and g₁₂ respectively as shown in FIG. 4B. Compounds g₁₁ and g₁₂ were then first reacted with thionyl chloride followed by aniline to yield compounds B₁₁ and B₁₂. The B₃₂ compound was prepared from compound g₁₂ by sequential reaction with thionyl chloride and sodium azide followed by Curtius rearrangement in refluxing toluene to give the diisocyanate g₃₂. The g₃₂ compounds was then reacted with aniline to provide compound B₃₂. Analogously B₂₁ and B₂₂ was prepared by a phenol reaction with compounds g₁₂ and g₁₁.

Monomers with —NH₂ on both sides can be synthesized if diaminobenzene is used instead of aniline. Also if a phenyl substituent is used instead of methyl the twist boat conformation can be stabilized further.

### EXAMPLE 3

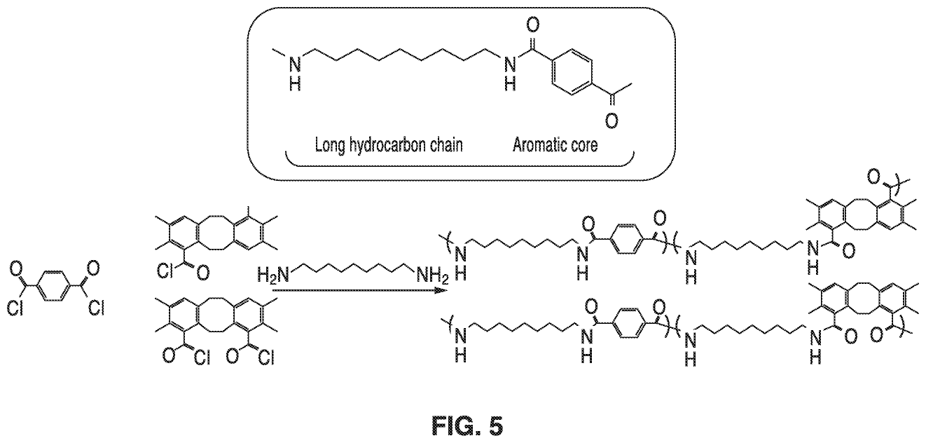

To further illustrate the invention, a scheme for incorporating the DBCOD unit into conventional packaging materials is described and shown in FIG. 5. The mismatch of the thermal expansion coefficient (CTE) of adjacent materials results in performance degradation and failure in current packing materials. This is a major reliability issue that affects the lifetime of packaged electronic assemblies. Thermal stress that occurs due to the fabrication process and thermal loading (device on and off) becomes more problematic with miniaturization. Examples of interface failures includes (a) thermal expansion mismatch between metal-polymer, Cu and polyimide and (b) solder joint failure due to strain generated from thermal expansion mismatch between polymer connector/housing and printed circuit board (PCB), especially during the STM (surface mount technology) reflow soldering processing. In order for the electronic package to survive relative high temperature processes (e.g. soldering) and operating conditions, materials adjacent to one another need to have similar CTEs. This generally requires lowering the packaging polymer CTE values. As shown in FIG. 5, the incorporation of the DBCOD units into conventional packing polymers can reduce or eliminate the mismatch.

### EXAMPLE 4

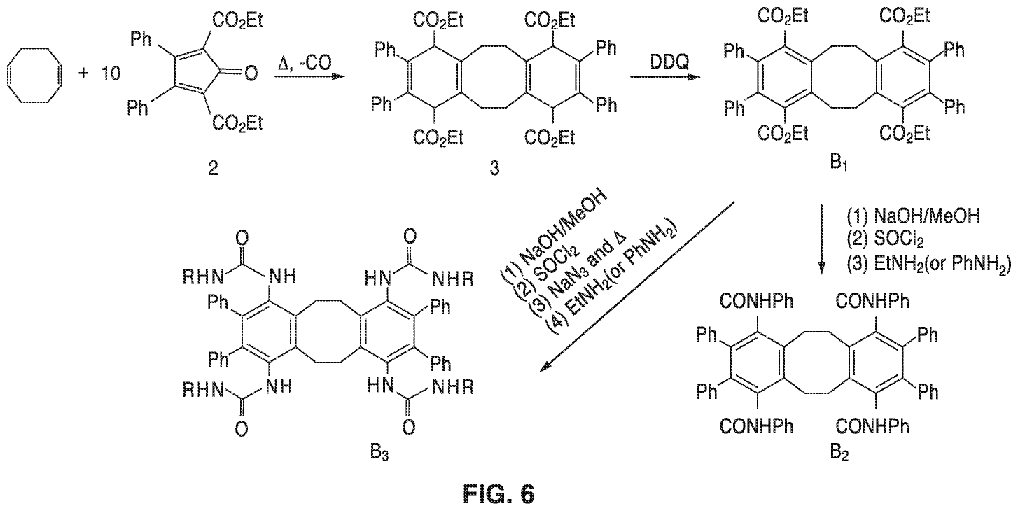

To further demonstrate the aspects of the invention, embodiments of DBCOD units were prepared to be used as a crosslinker and evaluated. Cyclooctadiene is known to undergo double Diels-Alder reactions with cyclopentadienone derivatives in high yield. The Diels-Alder route also provides another means of preparing main chain DBCOD polymers and thus the effect of phenyl substituents on conformational preference is of interest. In one embodiment shown in FIG. 6, the process began with the synthesis of a cyclopentadienone derivative (compound 2) using conventional procedures. Adding 1,5-cyclooctadiene dropwise into (compound 2) will yield the precursor (compound 3) in which the fused 6-8-6 ring system has two double bonds in the six membered rings. Oxidative aromatization with 2,3-Dichloro-5,6-dicyano-1,4-benzoquinone (DDQ) provided the desired DBCOD-containing molecule B₁. Once the tetrafunctional ester B₁ is in hand, standard carboxylic acid functional group manipulation will be used to generate hydrogen bond-active moieties, e.g. amide and urea. If EtNH₂ was used there were 4 —NH₂ groups per molecule.

Referring now to FIG. 7, it can be seen that several different substitution patterns are possible on the DBCOD base structure. Even though groups A and B are all tetra-functionalized, there are functional differences between groups A and B. In group B, each functional group is next to a phenyl ring. The effect of peripheral patterns, i.e. the π-π interaction (with four phenyl rings for B vs. no phenyl rings for A) on the equilibrium position will be delineated. The group B members can be only used as a crosslinker whereas the members of group C can be functionalized for polymerization to form main-chain based DBCOD polymers.

### EXAMPLE 5

To demonstrate the sensitivity of the NTE coefficient to the local environment of the DBCOD units, 3,4′-oxydianiline (3,4′-ODA) and oxydianiline (4,4′-ODA) as shown in FIG. 2A and FIG. 2B. were fabricated and evaluated. A triblock copolymer consisting of a polyarylamide segment that contained benzocyclobutene (BCB) that was connected to a poly(ethylene glycol) (PEG) segment on each side, was synthesized. After drop-casting the polymer solution into a mold followed by solvent evaporation, the film underwent a two-stage annealing: 8 hours at 320° C. for PEG removal and then 16 hours at 350° C. for the formation of DBCODs via the dimerization of BCBs.

In addition to pure 3,4′-ODA and 4,4′-ODA, mixtures of 3,4′-ODA and 4,4′-ODA with molar ratios of 1:3 and 3:1 were used to prepare triblock polymers to introduce different degrees of structural randomness into the films.

Thermogravimetric analysis (TGA) of these triblock polymers indicated that the amounts of PEG were about 40 wt % for all the four of the as synthesized polymers. However, the morphologies of the annealed films were significantly different. Slight changes in chemical structure lead to drastic differences in morphology as seen with atomic force microscope (AFM) phase images.

The “4,4′-ODA” polymer film displayed a highly ordered nanoscale fibril-like structure. In comparison, the “3,4′-ODA” polymer film was much less ordered, consisting of short worm like structures randomly aggregated with visible voids. This was observed because asymmetric substituted amides were chaotically distributed along a polymer chain in the “3,4′-ODA” polymer. With an increase of the amount of 3,4′-ODA in the polymer, disjointed nanofilaments, i.e, bamboo-like nanostructure, and more voids could be observed.

X-ray diffraction (XRD) and polarized optical microscopic analysis were performed to study the degree of order of “4,4′-ODA” and “3,4′-ODA” polymer films. The XRD pattern of the “4,4′-ODA” polymer film showed a small and sharp peak at 5.7 indicating the presence of crystalline domains. The peak at 5.7 observed in the “4,4′-ODA” polymer could also be found in the XRD pattern of the synthesized “4,4′-ODA” polyarylamide polymer suggesting that the dimerization of BCBs has little impact on the order and the ordered nanofabric-like morphology is well preserved. On the other hand, XRD analysis of “3,4′-ODA” polymer film showed no clear peaks indicating that it was an amorphous film.

The polymer films were further characterized by a modulated differential scanning calorimeter (DSC) at a temperature region in between 170° C. and 440° C. The DSC analysis indicated that the “3,4′-ODA” polymer film possessed a glass transition temperature with onset temperature at 300° C. On the other hand, due to the crystalline nature of the “4,4′ ODA” polymer film, no glass transition temperature was observed.

To examine the impact of local environmental difference on the DBCOD conformational process, DSC analysis for “3,4′-ODA” and “4,4′-ODA” polymer films was conducted around the room temperature region from −25° C. to 165° C. Reversible endothermic peaks were observed for both polymer films, which are attributed to the DBCOD conformational change. The endothermic peak temperature for the “3,4′-ODA” polymer film was approximately 10° C. lower than that of the “4,4′-ODA” polymer film. This indicated that the DBCOD moiety could more readily undergo the conformational change in “3,4′-ODA” polymer film, since it offered a less constrained local environment for facilitating the DBCOD conformational change. According to DSC, the area of the endothermic peaks for both polymer films are comparable, indicating that the enthalpy changes are similar in this temperature range. There were no noticeable peaks at the same temperature region. The fact that in the absence of DBCOD formation, no thermodynamic transition was observed, further indicated that the endothermic peak is due to the DBCOD conformational change.

Mechanical testing was also employed to study the effect of this slight change of local environment on macroscopic thermal contraction. In a typical test, a polymer film was placed in a load cell and stretched by a preload of 0.1 N. The generated stress in response to NIR irradiation at a constant strain was plotted. To enhance the photothermal effect, few-walled carbon nanotubes (FWCNTs) were blended with a triblock polymer before film formation. It was shown that 0.5 wt % FWCNTs can effectively absorb MR without altering the morphology. The generated contraction stress of polymer films under 970 nm NIR irradiation was also evaluated. At a temperature rise about 7° C. from room temperature, the contraction stress of the “3,4′-ODA” polymer film is about 100 kPa which is almost two times the amount of stress generated by the “4,4′-ODA” polymer film.

To confirm the effect of local environment on thermal contraction on the DBCOD conformational change, polymer films using different stoichiometric amounts of 3,4′-ODA and 4,4′-ODA were prepared and examined. The degree of linear thermal contraction of all of the polymer films as a function of temperature rise was evaluated. The contraction stress reached saturation at 34° C. for the “3,4′-ODA” polymer film whereas the saturation temperature for the “4,4′-ODA” polymer is about 42° C. The slight reduction of linear thermal contraction at temperature higher than the saturation temperature might be due to the increased contribution of normal thermal expansion resulting from anharmonicity of interatomic potential. The NTE coefficients of DBCOD polymer films prepared with 3,4′-ODA, 1:3 and 3:1 mixtures of 3,4′-ODA and 4,4′-ODA, 4,4′-ODA were −2350±73 ppm/K, −1952±38 ppm/K, −1228±65 ppm/K and −1140±64 ppm/K respectively. This demonstrated that the NTE value can be engineered by adjusting the stoichiometry.

Accordingly, the introduction of molecular structural randomness can significantly reduce crystallinity and an amorphous-like physical environment can greatly facilitate the DBCOD conformational transition process resulting in NTE values doubling from −1140 ppm/K in a polymer with more ordered crystalline structures, to −2350 ppm/K in a completely amorphous polymer. Together with the fact that NTE can be rationally tuned by adjusting stoichiometry demonstrates that control over molecular design and the local environment surrounding DBCOD units allows control over the macroscopic mechanoresponse of the final material.

### EXAMPLE 6

To further demonstrate the operational characteristics of the materials and methods for producing thermally mechanoresponsive materials, carbocyclic monomers containing 1,2:5,6-dibenzocyclooctadiene (DBCOD) units were synthesized as illustrated in FIG. 1B and films of the corresponding polymers were produced with different amounts of DBCOD located in the polymer main chain.

In this illustration, DBCOD-containing functional monomers and corresponding polyarylamides where DBCODs are located in the main chain were prepared according to the pathways shown in FIG. 8A. Starting from commercial dibenzosuberone (compound 1 of FIG. 8A), the Wittig-HTIB ring expansion reaction was carried out to generate an eight membered cyclooctanone (compound 2) in good yield (82%), and standard reduction conditions by LiAlH₄—AlCl₃ were applied to generate DBCOD (compound 3).

Formylation of (compound 3) via the Rieche reaction gave two products, 2,8-dicarbaldehyde-substituted DBCOD and 2,9-dicarbaldehyde-substituted-DBCOD (compound 4), with the isolated yield of 16% and 42%, respectively. The major component (compound 4) was subsequently transformed to target compound 5 via a standard Pinnick oxidation reaction converting aldehyde to carboxyl groups. The combined yield of five step organic transformations for the dicarboxylated product of DBCOD-COOH was 22%.

Compound 5 of FIG. 8A was available for functionalization to produce di-COOH-substituted DBCOD monomers. The Yamazaki-Higashi phosphorylation polycondensation technique was used to prepare the polyarylamides such as the one illustrated in FIG. 8B. A series of DBCOD-containing main-chain polyarylamides was prepared from (compound 5) (DBCOD-COOH), 4,4-oxydibenzoic acid (OBA), and 3,4-oxydianiline (ODA) by the direct polycondensation with triphenyl phosphate (TPP) and pyridine as condensing agents in N-methyl-2-pyrrolidone (NMP) solution containing CaCl₂.

In this case, 3,4-ODA instead of 4,4-ODA was chosen because the resulting a mixture of para- and meta-substituted amides could offer a less crystalline structure that can facilitate the DBCOD conformational change. OBA was employed to regulate the amount of DBCOD in the polymer. The feeding molar ratio of monomers OBA:DBCOD-COOH:ODA was 1:0:1, 2:1:3, 1:1:2, 1:2:3, and 0:1:1, respectively. All the polymerizations proceeded homogeneously throughout the reaction and afforded clear highly viscous polymer solutions. The isolated polymers showed good solubility in high polar solvents such as dimethylformamide (DMF), dimethyl sulfoxide (DMSO), and NMP.

The molecular structures of the synthesized polymers were further characterized by nuclear magnetic resonance (NMR), Fourier transform-infrared spectroscopy (FT-IR), and gel permeation chromatography (GPC). Their thermal properties, optical properties and mechanical properties were evaluated by differential scanning calorimetry (DSC), thermogravimetric analysis (TGA), UV-vis-NIR spectrograph, and mechanical testing instruments. Then, the thermal expansion/contraction behaviors of the solution-casted polymer films were tested directly by thermomechanical analyzer (TMA), which showed substantial thermal contraction over a wide range of temperatures, with the observed optimal CTE value of −625 ppm/K (100-200° C.). Furthermore, DSC, variable-temperature nuclear magnetic resonance (VT-NMR), and density-functional theory (DFT) calculations were employed to reveal the driving force of unique thermal contracting behaviors.

The films produced from this DBCOD-based polymer showed reversible thermal contraction behavior with the negative thermal expansion (NTE) coefficient of −625 ppm/K (100-200° C.). Differential scanning calorimetry (DSC), variable-temperature nuclear magnetic resonance (VT-NMR), and density-functional theory (DFT) calculations indicated that the population of the chair conformer of DBCODs increased with the rise of temperature due to the conversion from the twist-boat to chair conformation. This led to giant thermal contraction. Furthermore, the value of the NTE coefficient could be adjusted by the amount of DBCODs and order of their surrounding physical environment.

Accordingly, the characteristics of the monomer platform and corresponding linear polymer materials that exhibits reversible thermal contraction where the NTE can be tuned with DBCOD content and local environment control was demonstrated. The new monomer platform can be covalently incorporated into a variety of polymeric materials to construct directional negative thermal expansion or zero expansion materials for the specific applications. This provides a platform for fabricating thermal contracting polymers, which have great potential applications in electronic packaging, photoelectric devices, aerospace engineering, etc.

### EXAMPLE 7

A simple automatous solar tracking system was fabricated to illustrate a practical device with heliotropic properties using materials with negative thermal contraction. Referring now to FIG. 9, a basic solar tracking system 100 is shown in the dark (left) and light exposed (right) configurations. In this illustration, each solar panel 102 is supported by a platform with three or more legs 104. The photocurrent output of a solar cell is normally a function of azimuth angle. As seen in FIG. 9, the exposure of support legs 104 to incident sunlight 106 will cause the linear contraction and reduction in size of the leg 104 causing the perpendicular platform and solar panel 102 to move from a generally horizontal position to an angled position in the direction of the rays of the sun.

### EXAMPLE 8

To further demonstrate the aspects of the technology, crosslinked anisotropic polymer films were prepared with oriented DBCOD units and films functionalized with carbon nanotubes. Carbon nanotubes were functionalized with carboxyphenyl groups by reacting 4-aminobenzoic acid with isoamyl nitrite at 60° C. This provides a pathway to form covalent linkage with amine terminated DBCOD-containing polymer chains during the film formation.

For comparison, there were two approaches taken to generating a global order in a polymer film so that the geometrical change from every individual DBCODs will be constructively summed up into an appreciable macroscopic contraction. In the first approach, a solution of DBCOD-containing polymer, p1 or p2, few-walled CNTs along with a crosslinker was cast into a custom mold. To induce global alignment, patterned substrates with surface grooves produced via soft lithography were used to align the polymer chains. After films were partially dried, laminar flow in conjunction with the bottom static surface force imposed by substrate topographic features coerce the long-range order.

A thin layer of SiO₂ was then deposited onto a patterned substrate. This was used as a release layer to lift off polymer films from substrates after the completion of the crosslinking. Two types of molds, 36 mm by 36 mm and 32 mm by 6 mm, were used to make films. The 36 by 36 mm mold was employed to make 30 mm by 4 mm films by cutting along horizontal and vertical directions. The presence of any film anisotropy was examined using mechanical characterization as well as spectroscopic analysis. To generate cohesive thermal contraction, polymer chains were crosslinked. A thermal treatment was performed to accelerate the crosslinking reaction.

In the second approach the starting solution was mixed into a polyurethane fiber network with meshes. Crosslinking was conducted in two-stages. A short and low temperature thermal treatment of 60° C. for 2 hrs lead to a low-density crosslinked network. After this first stage crosslinking, the film was formed with sufficient mechanical integrity. To align all DBCOD units, the final cure was carried out when the film was under tension.

The negative expansion films or structures can stand alone or be paired with another material. As illustrated in FIG. 10, a composite 110 of a directional negative expansion polymer film 112 can be coupled to a base layer 116.

For example, the DBCOD polymer layer 112 can be attached to attached as an aligned film onto a piezoelectric polymer base layer 116. The base layer 116 can respond to both heat as well as the mechanical movement of the top film 112.

In another embodiment, the top DBCOD polymer film layer 112 can have a coefficient of thermal expansion that is adjusted by changing the ratio of the components that is matched with the coefficient of thermal expansion of the material of the base layer 116. This will produce a composite with known thermal expansion characteristics. The composite could also be used in zero- or low-thermal-expansion composite settings.

It can be seen that the NIR or heat driven sub-molecular switch with high fatigue resistance, good chemical stability and potential high efficiency opens new opportunities for the creation of adaptive optics, NIR-based molecular, nano- and micro-manipulators and materials. The colossal negative thermal expansion coefficient of these tunable materials opens the possibility of creating composite materials with tailorable thermal expansion coefficients and provide dimensional stability benefits to the optical and semiconductor industries and mitigating thermal-residual stresses in structural engineering.

From the description herein, it will be appreciated that that the present disclosure encompasses multiple embodiments which include, but are not limited to, the following:

1. A thermally contractile material with a tunable coefficient of thermal expansion, comprising: a plurality of cross-linked polymer substituted s-dibenzocyclooctadiene (DBCOD) moieties; wherein the DBCOD moieties are located within a polymer main chain and not on polymer cross-linking sites; and wherein a coefficient of thermal expansion is tuned by the concentration of DBCOD moieties in the material and the environment surrounding each DBCOD moiety.

2. The material of any preceding or following embodiment, further comprising nanoscale carbon particles selected from the group of particles consisting of carbon nanotubes, few walled carbon nanotubes, carbon nanotubes functionalized with carboxyphenyl groups, carbon nanotubes functionalized with carboxylic acid groups, carbon nanotubes functionalized with amino groups and carbon nanotubes functionalized with chloride groups.

3. The material of any preceding or following embodiment, wherein the DBCOD moiety is bound to at least one first type of cross linkable polymer and bound to at least one second type of cross-linkable polymer.

4. The material of any preceding or following embodiment, wherein the first polymer comprises, 3,4′-oxydianiline (3,4′-ODA) and the second polymer comprises 4,4′-oxydianiline (4,4′-ODA).

5. The material of any preceding or following embodiment, further comprising a plurality of cross-linking molecules cross-linking the polymers of the polymer substituted DBCOD moieties.

6. The material of any preceding or following embodiment, further comprising a plurality of packing monomers or polymers cross-linked to the polymers of the DBCOD moiety.

7. The material of any preceding or following embodiment, further comprising a mixture of cross-linked polymer para substituted s-dibenzocyclooctadiene (DBCOD) moieties and cross-linked polymer meta substituted s-dibenzocyclooctadiene (DBCOD) moieties.

8. The material of any preceding or following embodiment, wherein the polymers are linear polymers with a long axis; wherein the DBCOD moiety has a direction of contraction and a direction of expansion; and wherein the long axis of the polymer is oriented in the same direction as the direction of contraction of the DBCOD moiety.

9. A composite of two dissimilar materials, comprising: (a) a first material with known expansion characteristics; and (b) a second material with a tunable coefficient of thermal expansion coupled to the first material; wherein expansion between the two dissimilar materials is approximately equal.

10. The composite of any preceding or following embodiment, wherein the first material is a material selected from the group of materials consisting essentially of a metal, a piezoelectric material, a ferromagnetic material, a metal oxide material and a thermoplastic material.

11. The composite of any preceding or following embodiment, wherein the second material comprises: a plurality of cross-linked polymer substituted s-dibenzocyclooctadiene (DBCOD) moieties; wherein a coefficient of thermal expansion is tuned by the concentration of DBCOD moieties in the material and the environment surrounding each DBCOD moiety.

12. The composite of any preceding or following embodiment, the second material further comprising nanoscale carbon particles selected from the group of particles consisting of carbon nanotubes, few walled carbon nanotubes, carbon nanotubes functionalized with carboxyphenyl groups; carbon nanotubes functionalized with carboxylic acid groups; carbon nanotubes functionalized with amino groups and carbon nanotubes functionalized with chloride groups.

13. The composite of any preceding or following embodiment, the second material further comprising a packing monomer or polymer cross-linked to the DBCOD substituted polymers.

14. The composite of any preceding or following embodiment, wherein the packing polymer and the substituted DBCOD monomers are mixed in a DBCOD monomer to second monomer or polymer ratio in the range of 2% to 60%.

15. The composite of any preceding or following embodiment, the second material further comprising a cross-linking agent, a packing monomer or polymer and the DBCOD monomers.

16. A composite of two dissimilar materials, comprising: (a) a first material with known expansion characteristics; and (b) a second material with a tunable coefficient of thermal expansion coupled to the first material; (c) wherein expansion between the two dissimilar materials is tuned to be substantially different; and (d) wherein the differences in thermal expansion cause the composite to bend.

17. The composite of any preceding or following embodiment, wherein the first material is a material selected from the group of materials consisting essentially of a metal, a piezoelectric material, a ferromagnetic material, a metal oxide material and a thermoplastic material.

18. The composite of any preceding or following embodiment, wherein the second material comprises: a plurality of cross-linked polymer substituted s-dibenzocyclooctadiene (DBCOD) moieties; wherein a coefficient of thermal expansion is tuned by the concentration of DBCOD moieties in the material and the environment surrounding each DBCOD moiety.

19. The composite of any preceding or following embodiment, the second material further comprising: nanoscale carbon particles selected from the group of particles consisting of carbon nanotubes, few walled carbon nanotubes, carbon nanotubes functionalized with carboxyphenyl groups; carbon nanotubes functionalized with carboxylic acid groups; carbon nanotubes functionalized with amino groups and carbon nanotubes functionalized with chloride groups.

20. The composite of any preceding or following embodiment, the second material further comprising: a plurality of packing monomers or polymers cross-linked to the polymers of the DBCOD moiety.

21. The composite of any preceding or following embodiment, the second material further comprising: a plurality of cross-linking molecules cross-linking the polymers of the polymer substituted DBCOD moieties.

22. A method of producing a contractile material with a tunable coefficient of thermal expansion, the method comprising: (a) producing dibenzocyclooctodiene (DBCOD) functional monomers, the monomers having one or more positions on benzyl rings capable of substitution; (b) substituting one or more positions on benzyl rings of the DBCOD monomer with at least one substituent; and (c) crosslinking the substituted DBCOD monomers to produce a final product; (d) wherein negative thermal expansion of the final product is controlled by the selection of the position and identity of substituents on the benzyl rings of the DBCOD moiety.

23. The method of any preceding or following embodiment, further comprising: mixing substituted DBCOD monomers with at least one type of a second monomer or polymer; and polymerizing the mixture of monomers or polymers and the substituted DBCOD monomers to produce a final polymerized product.

24. The method of any preceding or following embodiment, wherein the packing polymer and the substituted DBCOD monomers are mixed in a DBCOD monomers to second monomer or polymer ratio in the range of 2% to 60%.

25. The method of any preceding or following embodiment, further comprising: mixing a cross-linking agent with substituted DBCOD monomers and at least one type of a second monomer or polymer; and polymerizing the mixture of the monomers or polymers, cross-linking agent and substituted DBCOD monomers to produce a final polymerized product.

26. The method of any preceding or following embodiment, further comprising: aligning DBCOD-containing polymer chains in a substantially similar direction.

27. A method of producing a contractile material with a tunable coefficient of thermal expansion, the method comprising: (a) producing dibenzocyclooctodiene containing monomers; (b) mixing packaging polymers with the dibenzocyclooctodiene containing monomers; and (c) polymerizing the mixture of packaging polymers with the dibenzocyclooctodiene containing monomers to produce a polymerized product; (d) wherein the coefficient of thermal expansion of the polymerized product can be determined by the total amount of dibenzocyclooctodiene containing monomers in the final product composition.

28. The method of any preceding or following embodiment, wherein the packing polymer comprises a cross-linking agent.

29. The method of any preceding or following embodiment, wherein the packing polymer and the dibenzocyclooctodiene containing monomers are mixed with in a monomer to packing polymer ratio in the range of 2% to 60%.

30. A contractile material, comprising: a polymerized mixture of packaging polymers with the dibenzocyclooctodiene containing monomers to produce a polymerized product; wherein the coefficient of thermal expansion of the polymerized product can be determined by the total amount of dibenzocyclooctodiene containing monomers in the final product composition.

As used herein, the singular terms “a,” “an,” and “the” may include plural referents unless the context clearly dictates otherwise. Reference to an object in the singular is not intended to mean “one and only one” unless explicitly so stated, but rather “one or more.”

As used herein, the term “set” refers to a collection of one or more objects. Thus, for example, a set of objects can include a single object or multiple objects.

As used herein, the terms “substantially” and “about” are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

Although the description herein contains many details, these should not be construed as limiting the scope of the disclosure but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A thermally contractile material with a tunable coefficient of thermal expansion, comprising:
a plurality of cross-linked polymer substituted s-dibenzocyclooctadiene (DBCOD) moieties;
wherein the DBCOD moieties are located within a polymer main chain and not on polymer cross-linking sites; and
wherein a coefficient of thermal expansion is tuned by the concentration of DBCOD moieties in the material and the environment surrounding each DBCOD moiety.

2. The material of claim 1, further comprising nanoscale carbon particles selected from the group of particles consisting of carbon nanotubes, few walled carbon nanotubes, carbon nanotubes functionalized with carboxyphenyl groups, carbon nanotubes functionalized with carboxylic acid groups, carbon nanotubes functionalized with amino groups and carbon nanotubes functionalized with chloride groups.

3. The material of claim 1, wherein said DBCOD moiety is bound to at least one first type of cross linkable polymer and bound to at least one second type of cross-linkable polymer.

4. The material of claim 3, wherein said first polymer comprises, 3,4′-oxydianiline (3,4′-ODA) and said second polymer comprises 4,4′-oxydianiline (4,4′-ODA).

5. The material of claim 1, further comprising a plurality of cross-linking molecules cross-linking said polymers of said polymer substituted DBCOD moieties.

6. The material of claim 1, further comprising a plurality of packing monomers or polymers cross-linked to the polymers of the DBCOD moiety.

7. The material of claim 1, further comprising a mixture of cross-linked polymer para substituted s-dibenzocyclooctadiene (DBCOD) moieties and cross-linked polymer meta substituted s-dibenzocyclooctadiene (DBCOD) moieties.

8. The material of claim 1, wherein:
said polymers are linear polymers with a long axis;
wherein said DBCOD moiety has a direction of contraction and direction of expansion; and
wherein said long axis of said polymer is oriented in the same direction as the direction of contraction of the DBCOD moiety.

9. A composite of two dissimilar materials, comprising:
(a) a first material with known expansion characteristics; and
(b) a second material with a tunable coefficient of thermal expansion coupled to the first material;
wherein expansion between the two dissimilar materials is approximately equal.

10. The composite of claim 9, wherein the first material is a material selected from the group of materials consisting essentially of a metal, a piezoelectric material, a ferromagnetic material, a metal oxide material and a thermoplastic material.

11. The composite of claim 9, wherein the second material comprises:
a plurality of cross-linked polymer substituted s-dibenzocyclooctadiene (DBCOD) moieties;
wherein a coefficient of thermal expansion is tuned by the concentration of DBCOD moieties in the material and the environment surrounding each DBCOD moiety.

12. The composite of claim 11, said second material further comprising nanoscale carbon particles selected from the group of particles consisting of carbon nanotubes, few walled carbon nanotubes, carbon nanotubes functionalized with carboxyphenyl groups; carbon nanotubes functionalized with carboxylic acid groups; carbon nanotubes functionalized with amino groups and carbon nanotubes functionalized with chloride groups.

13. The composite of claim 11, said second material further comprising a packing monomer or polymer cross-linked to the DBCOD substituted polymers.

14. The composite of claim 13, wherein the packing polymer and the substituted DBCOD monomers are mixed in a DBCOD monomer to second monomer or polymer ratio in the range of 2% to 60%.

15. The composite of claim 11, said second material further comprising a cross-linking agent, a packing monomer or polymer and the DBCOD monomers.

16. A composite of two dissimilar materials, comprising:
(a) a first material with known expansion characteristics; and
(b) a second material with a tunable coefficient of thermal expansion coupled to the first material;
(c) wherein expansion between the two dissimilar materials is tuned to be substantially different; and
(d) wherein the differences in thermal expansion cause the composite to bend.

17. The composite of claim 16, wherein the first material is a material selected from the group of materials consisting essentially of a metal, a piezoelectric material, a ferromagnetic material, a metal oxide material and a thermoplastic material.

18. The composite of claim 16, wherein the second material comprises:
a plurality of cross-linked polymer substituted s-dibenzocyclooctadiene (DBCOD) moieties;
wherein a coefficient of thermal expansion is tuned by the concentration of DBCOD moieties in the material and the environment surrounding each DBCOD moiety.

19. The composite of claim 16, said second material further comprising: nanoscale carbon particles selected from the group of particles consisting of carbon nanotubes, few walled carbon nanotubes, carbon nanotubes functionalized with carboxyphenyl groups; carbon nanotubes functionalized with carboxylic acid groups; carbon nanotubes functionalized with amino groups and carbon nanotubes functionalized with chloride groups.

20. The composite of claim 16, said second material further comprising: a plurality of packing monomers or polymers cross-linked to the polymers of the DBCOD moiety.

21. The composite of claim 16, said second material further comprising: a plurality of cross-linking molecules cross-linking said polymers of said polymer substituted DBCOD moieties.

22. A method of producing a contractile material with a tunable coefficient of thermal expansion, the method comprising:
(a) producing dibenzocyclooctodiene (DBCOD) functional monomers, said monomers having one or more positions on benzyl rings capable of substitution;
(b) substituting one or more positions on benzyl rings of said DBCOD monomer with at least one substituent; and
(c) crosslinking said substituted DBCOD monomers to produce a final product;
(d) wherein negative thermal expansion of the final product is controlled by the selection of the position and identity of substituents on the benzyl rings of the DBCOD moiety.

23. The method of claim 22, further comprising:
mixing substituted DBCOD monomers with at least one type of a second monomer or polymer; and
polymerizing the mixture of monomers or polymers and said substituted DBCOD monomers to produce a final polymerized product.

24. The method of claim 22, wherein the packing polymer and the substituted DBCOD monomers are mixed in a DBCOD monomers to second monomer or polymer ratio in the range of 2% to 60%.

25. The method of claim 22, further comprising:
mixing a cross-linking agent with substituted DBCOD monomers and at least one type of a second monomer or polymer; and
polymerizing the mixture of said monomers or polymers, cross-linking agent and substituted DBCOD monomers to produce a final polymerized product.

26. The method of claim 22, further comprising: aligning DBCOD-containing polymer chains in a substantially similar direction.

27. A method of producing a contractile material with a tunable coefficient of thermal expansion, the method comprising:
(a) producing dibenzocyclooctodiene containing monomers;
(b) mixing packaging polymers with said dibenzocyclooctodiene containing monomers; and
(c) polymerizing the mixture of packaging polymers with said dibenzocyclooctodiene containing monomers to produce a polymerized product;
(d) wherein the coefficient of thermal expansion of the polymerized product can be determined by the total amount of dibenzocyclooctodiene containing monomers in the final product composition.

28. The method of claim 27, wherein the packing polymer comprises a cross-linking agent.

29. The method of claim 27, wherein the packing polymer and the dibenzocyclooctodiene containing monomers are mixed with in a monomer to packing polymer ratio in the range of 2% to 60%.

30. A contractile material, comprising: a polymerized mixture of packaging polymers with said dibenzocyclooctodiene containing monomers to produce a polymerized product; wherein the coefficient of thermal expansion of the polymerized product can be determined by the total amount of dibenzocyclooctodiene containing monomers in the final product composition.
